(19) United States
(12) Patent Application Publication
(10) Pub. No.: US 2024/0182765 A1
(43) Pub. Date: Jun. 6, 2024

(54) POLYAMIC ACID COMPOSITION, POLYIMIDE COMPOSITION, ADHESIVE AND LAMINATE

(71) Applicant: MITSUI CHEMICALS, INC., Chuo-ku, Tokyo (JP)

(72) Inventors: Masaki OKAZAKI, Chiba-shi, Chiba (JP); Ko TAKASE, Chiba-shi, Chiba (JP); Tatsuhiro URAKAMI, Ichihara-shi, Chiba (JP); Yoshihiro SAKATA, Ichikawa-shi, Chiba (JP)

(73) Assignee: MITSUI CHEMICALS, INC., Chuo-ku, Tokyo (JP)

(21) Appl. No.: 18/551,460

(22) PCT Filed: Mar. 11, 2022
(86) PCT No.: PCT/JP2022/011075

§ 371 Date: Sep. 20, 2023

(30) Foreign Application Priority Data
Mar. 22, 2021 (JP) 2021-047434

(51) Int. Cl. C09J 179/08; C08G 73/10

(52) U.S. Cl. CPC C09J 179/08; C08G 73/1082; C09J 2479/00

(57) ABSTRACT

The polyamic acid composition according to the present disclosure comprises a polyamic acid. The monomers constituting the polyamic acid include, relative to the total monomers, 30-95 mol % of monomer (A) that has a diphenyl ether skeleton represented by general formula (1) or (2) but no benzophenone skeleton, and 0-5 mol % of monomer (B) that has a benzophenone skeleton. The diamines constituting the polyamic acid include aromatic diamine (β1) that has a diphenyl ether skeleton represented by general formula (2) and aliphatic diamine (β2) represented by general formula (3) or (4), and the molar ratio b/a of the diamines b to tetracarboxylic dianhydride a constituting the polyamic acid is 0.90-0.999.

### TECHNICAL FIELD

The present disclosure relates to a polyamic acid composition, a polyimide composition, an adhesive, and a laminate.

Background Art

In general, adhesives used for electronic circuit substrates, semiconductor devices, and the like have been epoxy resins. However, epoxy resins do not have sufficient heat resistance or flexibility and require a long time for the thermosetting reaction.

On the other hand, thermoplastic polyimides are known to have high heat resistance and flexibility and to require a relatively short time for the thermosetting reaction. Thus, use of varnishes or films including thermoplastic polyimides has been studied.

For example, there are methods of drying coating films of varnishes prepared by dissolving polyimides in solvents (solvent-soluble polyimide varnishes) (for example, Patent Literatures 1 to 3). Patent Literature 1 discloses a solvent-soluble polyimide obtained by causing a reaction between an acid dianhydride component including benzophenonetetracarboxylic dianhydride and a diamine component including a specific siloxane compound. Patent Literature 2 discloses a solvent-soluble polyimide obtained by causing a reaction between an acid dianhydride component including benzophenonetetracarboxylic dianhydride and a diamine component including a compound having a specific sulfonic acid skeleton. Patent Literature 3 discloses a polyimide resin composition including an aromatic tetracarboxylic dianhydride having a benzophenone skeleton and an aromatic diamine.

### CITATION LIST

### Patent Literature

### PTL 1

Japanese Patent Application Laid-Open No. HE19-255780

### PTL 2

### Japanese Patent Application Laid-Open No. 2001-310336

### PTL 3

### SUMMARY OF INVENTION

### Technical Problem

However, the films obtained from the polyimide varnishes of PTLS 1 and 2 do not have sufficient flexibility. Thus, such compositions including the polyimides are not suitable for applications in which flexibility is required.

In manufacturing steps of electronic circuit substrates, semiconductor devices, and the like, thermoplastic polyimide films having been provided as adhesives are desirably peeled without adhesive residues. The peeling methods are laser liftoff (LLO), mechanical peeling, and methods of using a solvent or the like to cause dissolution-removal; from the viewpoint of performing easy peeling at low costs, dissolution-removal using a solvent or the like is desirable. The polyimide composition of PTL 3 has high heat resistance and flexibility but needs to be further improved, in the form of films, in dissolvability (re-dissolvability) in solvents.

Manufacturing steps of electronic circuit substrates, semiconductor devices, and the like involve heating steps such as electrode film formation and redistribution steps and hence thermoplastic polyimide films used in such steps need to have heat resistance that resists the high temperatures.

Under such circumstances, the present disclosure has been made: an object is to provide a polyamic acid composition that can provide a polyimide film having high heat resistance and a good mechanical property (elongation) and having high re-dissolvability. Another object is to provide a polyimide composition and an adhesive that use the polyamic acid composition.

### Solution to Problem

A polyamic acid composition according to the present disclosure includes:
a polyamic acid provided by polycondensation of monomers that are a tetracarboxylic dianhydride and a diamine,
in which the monomers constituting the polyamic acid include
relative to a total amount of the monomers constituting the polyamic acid,
30 to 97 mol % of a monomer (A) not having a benzophenone skeleton but having a diphenyl ether skeleton represented by General formula (1) or (2), and
0 to 5mol % of a monomer (B) having a benzophenone skeleton,
the diamine constituting the polyamic acid includes
an aromatic diamine (β1) not having a benzophenone skeleton but having a diphenyl ether skeleton represented by General formula (2), and
an aliphatic diamine (β2) represented by General formula (3) or an aliphatic diamine (β2) represented by General formula (4),
a molar ratio of the diamine to the tetracarboxylic dianhydride constituting the polyamic acid is diamine/tetracarboxylic dianhydride=0.90 to 0.999,

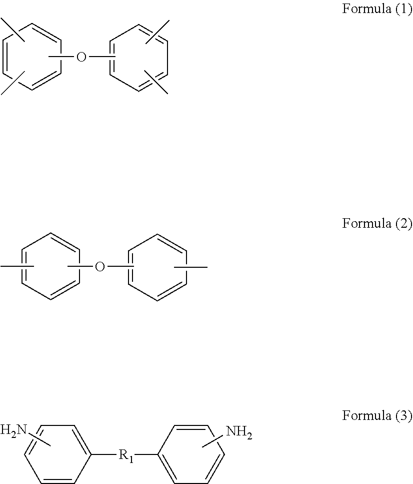

(in General formula (3), R₁ is an aliphatic chain having a main chain constituted by one or more atoms of C, N, and O and a total number of atoms constituting the main chain is 7 to 500; and
the aliphatic chain further optionally has a side chain constituted by one or more atoms of C, N, H, and O and a total number of atoms constituting the side chain is 10 or less),

H₂N—R₂—NH₂ Formula (4)
(in General formula (4), R₂ is an aliphatic chain having a main chain constituted by one or more atoms of C, N, and O and a total number of atoms constituting the main chain is 5 to 500; and
the aliphatic chain further optionally has a side chain constituted by one or more atoms of C, N, H, and O and a total number of atoms constituting the side chain is 10 or less).

A polyimide composition according to the present disclosure includes a polyimide provided by polycondensation of monomers that are a tetracarboxylic dianhydride and a diamine, wherein the monomers constituting the polyimide include, relative to a total amount of the monomers constituting the polyimide, 30 to 97mol % of a monomer (A) not having a benzophenone skeleton but having a diphenyl ether skeleton represented by General formula (1) or (2), and 0 to 5mol % of a monomer (B) having a benzophenone skeleton, the diamine constituting the polyimide includes an aromatic diamine (β1) not having a benzophenone skeleton but having a diphenyl ether skeleton represented by General formula (2), and an aliphatic diamine (β2) represented by General formula (3) or an aliphatic diamine (β2) represented by General formula (4), a molar ratio of the diamine to the tetracarboxylic dianhydride constituting the polyimide is diamine/tetracarboxylic dianhydride=0.90 to 0.999,

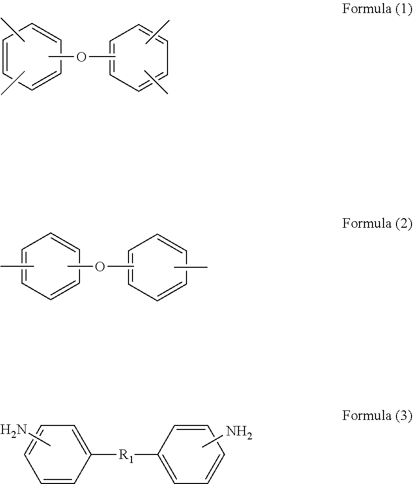

(in General formula (3), R₁ is an aliphatic chain having a main chain constituted by one or more atoms of C, N, and O and a total number of atoms constituting the main chain is 7 to 500; and
the aliphatic chain further optionally has a side chain constituted by one or more atoms of C, N, H, and O and a total number of atoms constituting the side chain is 10 or less),

H₂NR₂—NH₂ Formula (4)
(in General formula (4), R₂ is an aliphatic chain having a main chain constituted by one or more atoms of C, N, and O and a total number of atoms constituting the main chain is 5 to 500; and
the aliphatic chain further optionally has a side chain constituted by one or more atoms of C, N, H, and O and a total number of atoms constituting the side chain is 10 or less).

An adhesive according to the present disclosure includes the polyimide composition according to the present disclosure.

A laminate according to the present disclosure includes a substrate and a resin layer disposed on the substrate and including the polyimide composition according to the present disclosure.

### Advantageous Effects of Invention

The present disclosure can provide a polyamic acid composition that can provide a polyimide film having high heat resistance and a good mechanical property (elongation) and having high re-dissolvability. The present disclosure can also provide a polyimide composition and an adhesive that use the polyamic acid composition.

### BRIEF DESCRIPTION OF DRAWINGS

FIG. 1 is a schematic view of a test piece used in a tensile break test; and

FIGS. 2A to 2H are schematic sectional views of an example of a process of processing a silicon substrate using, as a temporarily fixing adhesive, a polyimide composition according to the present disclosure.

### DESCRIPTION OF EMBODIMENTS

In this Description, numerical ranges described using “to” mean ranges including a value before “to” and a value after “to” respectively as the lower limit value and the upper limit value. In this Description, of numerical ranges described in series, the upper limit value or the lower limit value of a numerical range may be replaced by the upper limit value or the lower limit value of another one of the numerical ranges described in series.

The inventors of the present invention performed thorough studies and, as a result, have found the following: 1) a polyamic acid having, at a molecular end, an acid anhydride group is used, 2) a predetermined amount or more of a monomer (A) not having a benzophenone skeleton but having a diphenyl ether skeleton is contained, and 3) the amount of a monomer (B) having a benzophenone skeleton is minimized (substantially not contained), so that, for the resultant polyimide film, with a good mechanical property being maintained, the re-dissolvability can be improved.

This mechanism has not been clarified but is inferred as follows.

A polyamic acid having, at a molecular end, an acid anhydride group is used, to thereby reduce interaction within molecular chains or between molecular chains of the resultant polyimide inferentially, to improve the dissolvability (re-dissolvability) of the resultant polyimide film in a solvent. In addition, because of, for example, a feature that the monomers constituting the polyamic acid substantially do not include the monomer (B) having a benzophenone skeleton to thereby suppress an increase in the degree of crosslinking due to a crosslinking reaction between the carbonyl group of the benzophenone skeleton and an amine moiety in the molecule of the polyamic acid, and a feature that a flexible structure derived from the monomer (A) having a diphenyl ether skeleton is included, the resultant polyimide film can have improved dissolvability (re-dissolvability) in a solvent.

Such polyimides having relatively flexible structures and having high re-dissolvability tend not to maintain heat resistance. To address this, in the present disclosure, 4) as the diamine constituting the polyamic acid, an aromatic diamine (β1) is further contained, to thereby improve the heat resistance of the resultant polyimide. As a result, unlike PTL 3, without formation of the hydrogen bond between the amino group at a molecular end of the polyamic acid and the carbonyl group of the benzophenone skeleton, high heat resistance can be obtained. Hereinafter, features of the present disclosure will be described.

1. Polyamic Acid composition

A polyamic acid composition according to the present disclosure includes a specific polyamic acid and, as needed, may further include another optional component such as a solvent.

1-1. Polyamic Acid

The monomers constituting the polyamic acid include a monomer (A) not having a benzophenone skeleton but having a diphenyl ether skeleton. Such a monomer (A) has a structure having, with appropriate rigidity being maintained, flexibility in which molecular chains are freely movable, so that packing between polyimide molecular chains tends to be suppressed inferentially. This inferentially results in (with the heat resistance of the resultant polyimide being maintained) improvement in the re-dissolvability of the polyimide film in a solvent. Note that the monomer (A) preferably does not have a biphenyl skeleton. Note that, for the monomers constituting the polyamic acid, the content of the monomer (B) having a benzophenone skeleton relative to the total amount of the monomers constituting the polyamic acid is 5 mol % or less, preferably less than 3 mol %, more preferably less than 1 mol %. This is because the carbonyl group of the monomer (B) having a benzophenone skeleton undergoes a crosslinking reaction with an amine moiety in the molecule of the polyamic acid, which tends to result in degradation of the re-dissolvability of the resultant polyimide film.

Specifically, the polyamic acid includes a polycondensation unit of a tetracarboxylic dianhydride and a diamine: the tetracarboxylic dianhydride includes an aromatic tetracarboxylic dianhydride (α1) not having a benzophenone skeleton but having a diphenyl ether skeleton, or the diamine includes an aromatic diamine (β1) not having a benzophenone skeleton but having a diphenyl ether skeleton (these are also collectively referred to as “monomer (A) not having a benzophenone skeleton but having a diphenyl ether skeleton”). Note that, for the tetracarboxylic dianhydride and the diamine, the content of an aromatic tetracarboxylic dianhydride (α3) having a benzophenone skeleton and an aromatic diamine (β4) having a benzophenone skeleton (these are also collectively referred to as “monomer (B) having a benzophenone skeleton”) relative to the total amount of the monomers constituting the polyamic acid is 5 mol % or less.

(Tetracarboxylic Dianhydride)

The tetracarboxylic dianhydride constituting the polyamic acid can include an aromatic tetracarboxylic dianhydride (α1) not having a benzophenone skeleton but having a diphenyl ether skeleton represented by General formula (1) or (2).

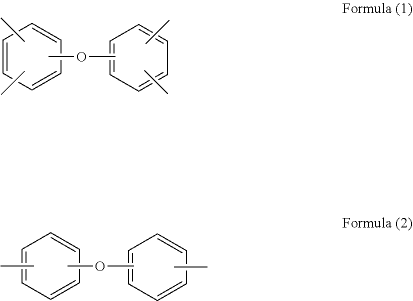

The aromatic tetracarboxylic dianhydride (α1) not having a benzophenone skeleton but having a diphenyl ether skeleton is preferably a compound represented by Formula (5) below.

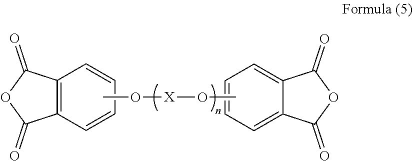

In General formula (5), X is a substituted or unsubstituted arylene group having 6 to 10 carbon atoms or a group represented by Formula (a) below. n represents 0 or 1 and is preferably 0.

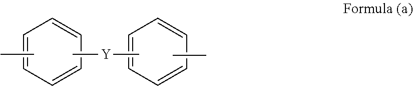

Examples of the substituted or unsubstituted arylene group having 6 to 10 carbon atoms include a phenylene group and a naphthylene group. The substituent may be, for example, an alkyl group and a plurality of substituents may be linked together to form a ring. Examples of the ring include alicyclic rings such as a cyclohexane ring and a norbornane ring.

In Formula (a), Y represents a divalent group selected from the group consisting of an oxygen atom, a sulfur atom, a sulfonyl group, a methylene group, a fluorene moiety, and —CR¹R²—(R¹ and R² are a substituted or unsubstituted alkyl group having 1 to 3 carbon atoms or a phenyl group).

Examples of, as R¹ and R², the substituted or unsubstituted alkyl group having 1 to 3 carbon atoms include a methyl group, an ethyl group, a propyl group, and a trifluoropropyl group. For example, —CR¹R²— may be an isopropylidene group or a hexafluoroisopropylidene group. R¹ and R² may be linked together to form a ring. Examples of the ring formed by linking R¹ and R² together include a cyclohexane ring and a cyclopentane ring: to such rings, aromatic rings such as benzene rings may be fused. Such linking groups have three-dimensionally distributed structures and hence tend to improve the re-dissolvability of the resultant polyimide.

Examples of the aromatic tetracarboxylic dianhydride (α1) not having a benzophenone skeleton but having a diphenyl ether skeleton include 4,4′-(4,4′-isopropylidenediphenoxy)bisphthalic anhydride, 1,3-bis(3,4-dicarboxyphenoxy)benzene dianhydride, 1,4-bis(3,4-dicarboxyphenoxy)benzene dianhydride, 4,4′-oxydiphthalic anhydride, 3,4′-oxydiphthalic anhydride, 3,3′-oxydiphthalic anhydride, and compounds described below. These can be used alone or in combination. Of these, from the viewpoint of availability, preferred is the compound represented by General formula (5) where n is 0 and preferred is 4,4′-oxydiphthalic anhydride.

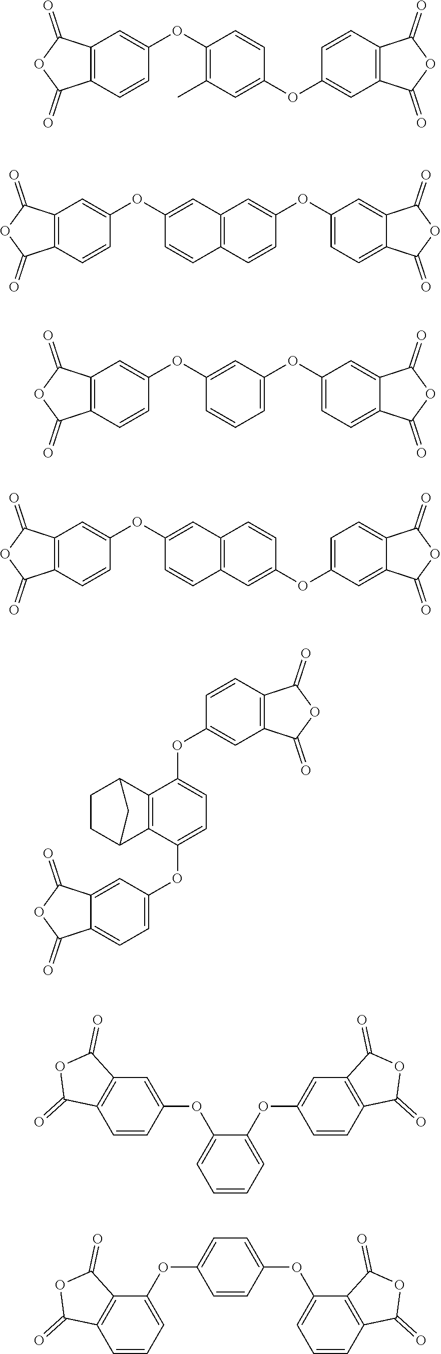

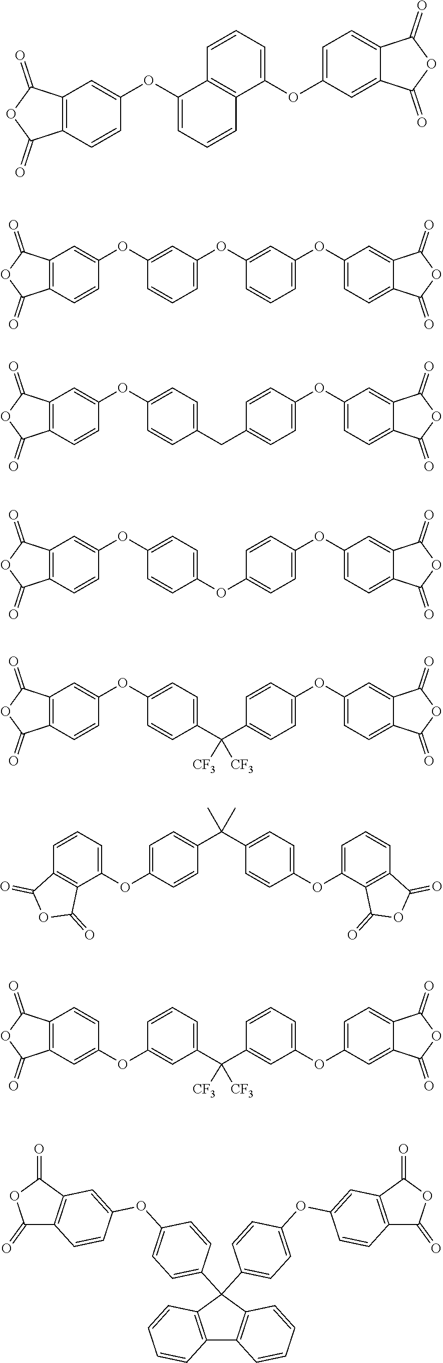

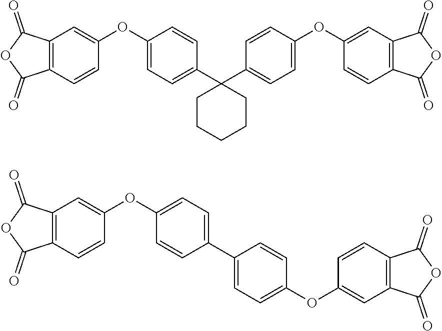

Note that the aromatic tetracarboxylic dianhydride (α1) not having a benzophenone skeleton but having a diphenyl ether skeleton preferably does not have a biphenyl skeleton.

The tetracarboxylic dianhydride constituting the polyamic acid may include, in addition to the aromatic tetracarboxylic dianhydride (α1) not having a benzophenone skeleton but having a diphenyl ether skeleton, another tetracarboxylic dianhydride. The other tetracarboxylic dianhydride is not particularly limited but is preferably, from the viewpoint of heat resistance, an aromatic tetracarboxylic dianhydride.

Examples of the aromatic tetracarboxylic dianhydride that can serve as the other tetracarboxylic dianhydride include pyromellitic dianhydride, 3,3′,4,4′-biphenyltetracarboxylic dianhydride, 1,1′,2,2′-biphenyltetracarboxylic dianhydride, 2,3,2′,3′-biphenyltetracarboxylic dianhydride, 1,2,2′,3-biphenyltetracarboxylic dianhydride, 2,2′,3,3′-biphenyltetracarboxylic dianhydride, bis(3,4-dicarboxyphenyl)sulfide dianhydride, bis(3,4-dicarboxyphenyl)sulfone dianhydride, bis(3,4-dicarboxyphenyl)methane dianhydride, 2,2-bis(3,4-dicarboxyphenyl)propane dianhydride, 2,2-bis(3,4-dicarboxyphenyl)-1,1,1,3,3,3-hexafluoropropane dianhydride, 1,3-bis(3,4-dicarboxyphenoxy)benzene dianhydride, 1,4-bis(3,4-dicarboxyphenoxy)benzene dianhydride, 4,4′-bis(3,4-dicarboxyphenoxy)biphenyl dianhydride, 2,2-bis [(3,4-dicarboxyphenoxy)phenyl]propane dianhydride, 2,3,6,7-naphthalenetetracarboxylic dianhydride, 1,4,5,8-naphthalenetetracarboxylic dianhydride, 2,2-bis(2,3-dicarboxyphenyl)propane dianhydride, 2,2-bis(2,3-dicarboxyphenyl)-1,1,1,3,3,3-hexafluoropropane dianhydride, bis(2,3-dicarboxyphenyl) ether dianhydride, bis(2,3-dicarboxyphenyl)sulfide dianhydride, bis(2,3-dicarboxyphenyl)sulfone dianhydride, dianhydride, 1,3-bis(2,3-dicarboxyphenoxy)benzene 1,4-bis(2,3-dicarboxyphenoxy)benzene dianhydride, 1,2,5,6-naphthalenetetracarboxylic dianhydride, 4,4′-isophthaloyldiphthalic anhydride, diazodiphenylmethane-3,3′,4,4′-tetracarboxylic dianhydride, diazodiphenylmethane-2,2′,3,3′-tetracarboxylic dianhydride, 2,3,6,7-thioxanthonetetracarboxylic dianhydride, 2,3,6,7-anthraquinonetetracarboxylic dianhydride, 2,3,6,7-xanthonetetracarboxylic dianhydride, and ethylenetetracarboxylic dianhydride.

When the tetracarboxylic dianhydride constituting the polyimide includes an aromatic ring such as a benzene ring, a portion of or the entirety of the hydrogen atoms on the aromatic ring may be substituted with a group selected from, for example, a fluoro group, a methyl group, a methoxy group, a trifluoromethyl group, and a trifluoromethoxy group. These may be used alone or in combination of two or more thereof.

The other tetracarboxylic dianhydride includes, from the viewpoint of, without considerably degrading the flexibility, obtaining high heat resistance, preferably an aromatic tetracarboxylic dianhydride, more preferably an aromatic tetracarboxylic dianhydride (α2) having a biphenyl skeleton such as 3,3′,4,4′-biphenyltetracarboxylic dianhydride, 1,2,1′,2′-biphenyltetracarboxylic dianhydride, 2,3,2′,3′-biphenyltetracarboxylic dianhydride, or 1,2,2′,3-biphenyltetracarboxylic dianhydride.

Note that, as described above, the tetracarboxylic dianhydride constituting the polyimide, from the viewpoint of obtaining high re-dissolvability, preferably substantially does not include the aromatic tetracarboxylic dianhydride (α3) having a benzophenone skeleton. Examples of the aromatic tetracarboxylic dianhydride (α3) having a benzophenone skeleton include 3,3′,4,4′-benzophenonetetracarboxylic dianhydride, 2,3,3′,4′-benzophenonetetracarboxylic dianhydride, and 2,2′,3,3′-benzophenonetetracarboxylic dianhydride.

(Diamine)

The diamine constituting the polyamic acid includes an aromatic diamine (β1) not having a benzophenone skeleton but having a diphenyl ether skeleton represented by General formula (2).

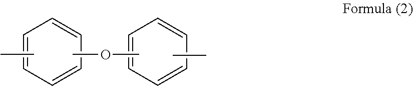

The aromatic diamine (β1) not having a benzophenone skeleton but having the diphenyl ether skeleton represented by General formula (2) preferably includes three or more aromatic rings: examples of the aromatic diamine (β1) include a compound represented by General formula (2-1).

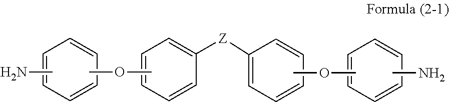

In General formula (2-1), Z represents a divalent group selected from the group consisting of an oxygen atom, a sulfur atom, a sulfonyl group, a methylene group, a fluorene moiety, and —CR¹R²— (R¹ and R² are each a substituted or unsubstituted alkyl group having 1 to 3 carbon atoms or a phenyl group).

Examples of, as R¹ and R², the alkyl group having 1 to 3 carbon atoms include a methyl group, an ethyl group, a propyl group, and a trifluoropropyl group. For example, —CR¹R²—may be an isopropylidene group or a hexafluoroisopropylidene group. R¹ and R² may be linked together to form a ring. Examples of the ring formed by linking R¹ and R² together include a cyclohexane ring and a cyclopentane ring: to such rings, aromatic rings such as benzene rings may be fused. Such linking groups have three-dimensionally distributed structures and hence tend to improve the re-dissolvability of the resultant polyimide.

Of the aromatic diamine (β1) not having a benzophenone skeleton but having the diphenyl ether skeleton represented by General formula (1), examples of the aromatic diamine (β1) including three or more aromatic rings include bis[4-(3-aminophenoxy)phenyl]sulfide, 1,3-bis(3-aminophenoxy)benzene, 1,3-bis(4-aminophenoxy)benzene, 1,3-bis(3-(3-aminophenoxy)phenoxy)benzene, 1,3-bis(3-(4-aminophenoxy)phenoxy)benzene, 1,3-bis(4-(3-aminophenoxy)phenoxy)benzene, 1,3-bis(3-(3-aminophenoxy)phenoxy)-2-methylbenzene, 1,3-bis(3-(4-aminophenoxy)phenoxy)-4-methylbenzene, 1,3-bis(4-(3-aminophenoxy)phenoxy)-2-ethylbenzene, 1,3-bis(3-(2-aminophenoxy)phenoxy)-5-sec-butylbenzene, 1,3-bis(4-(3-aminophenoxy)phenoxy)-2,5-dimethylbenzene, 1,3-bis(4-(2-amino-6-methylphenoxy)phenoxy)benzene, 1,3-bis(2-(2-amino-6-ethylphenoxy)phenoxy)benzene, 1,3-bis(2-(3-aminophenoxy)-4-methylphenoxy)benzene, 1,3-bis(2-(4-aminophenoxy)-4-tert-butylphenoxy)benzene, 1,4-bis(3-(3-aminophenoxy)phenoxy)-2,5-di-tert-butylbenzene, 1,4-bis(3-(4-aminophenoxy)phenoxy)-2,3-dimethylbenzene, 1,4-bis(3-(2-amino-3-propylphenoxy)phenoxy)benzene, 1,2-bis(3-(3-aminophenoxy)phenoxy)-4-methylbenzene, 1,2-bis(3-(4-aminophenoxy)phenoxy)-3-n-butylbenzene, 1,2-bis(3-(2-amino-3-propylphenoxy)phenoxy)benzene, 4,4′-bis(4-aminophenyl)-1,4-diisopropylbenzene, bis[4-(3-aminophenoxy)phenyl]methane, bis[4-(4-aminophenoxy)phenyl]methane, 2,2-bis[4-(3-aminophenoxy)phenyl]propane, 2,2-bis[4-(4-aminophenoxy)phenyl]propane, 2,2-bis[3-(3-aminophenoxy)phenyl]-1,1,1,3,3,3-hexafluoropropane, 2,2-bis [4-(4-aminophenoxy)phenyl]-1,1,1,3,3,3-hexafluoropropane, bis[4-(4-aminophenoxy)phenyl]ketone, bis[4-(4-aminophenoxy)phenyl] sulfide, bis[4-(3-aminophenoxy)phenyl] sulfoxide, bis[4-(aminophenoxy)phenyl] sulfoxide, bis [4-(3-aminophenoxy)phenyl] sulfone, bis[4-(4-aminophenoxy)phenyl] sulfone, and diamines represented by the following formulas.

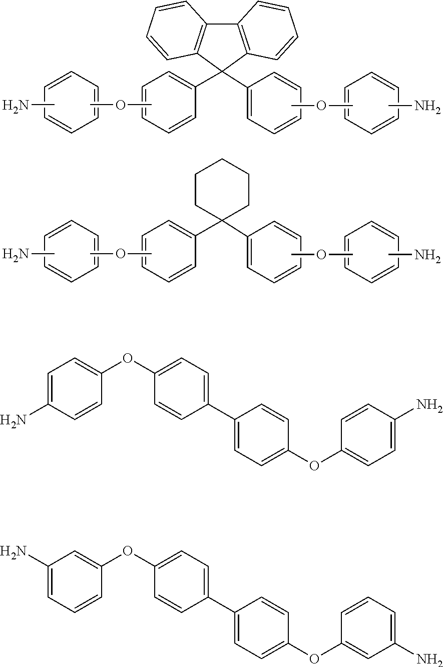

Of these, more preferred are aromatic diamines represented by General formula (2-1) such as 1,3-bis(3-aminophenoxy)benzene, 1,3-bis(4-aminophenoxy)benzene, and 2,2-bis[4-(4-aminophenoxy)phenyl]propane.

Note that the aromatic diamine (β1) not having a benzophenone skeleton but having a diphenyl ether skeleton preferably does not have a biphenyl skeleton.

The diamine constituting the polyamic acid preferably further includes an aliphatic diamine (β2). The aliphatic diamine (β2) is preferably an aliphatic diamine represented by General formula (3) or (4). The polyamic acid composition may include any one of or both of aliphatic diamines represented by General formulas (3) and (4).

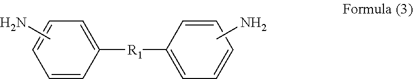

H₂N—R₂—NH₂ Formula (4)

R₁ in General formula (3) and R₂ in General formula (4) represent an aliphatic chain having a main chain constituted by one or more atoms of C, N, and O, preferably an aliphatic chain having a main chain including one or more C. The total number of atoms constituting the main chain is preferably 5 to 500, more preferably 10 to 500, still more preferably 21 to 300, still yet more preferably 50 to 300. In R₁ in General formula (3), the main chain is, of the aliphatic chain linking together the two phenyl groups at the molecular ends, a chain constituted by atoms other than the atoms constituting the side chains: in R₂ of General formula (4), the main chain is, of the aliphatic chain linking together the two amino groups at the molecular ends, a chain constituted by atoms other than the atoms constituting the side chains.

Examples of the main chain constituting the aliphatic chain and constituted by one or more atoms of C, N, and O include a main chain having a structure derived from a polyalkylene polyamine such as diethylenetriamine, triethylenetetramine, or tetraethylenepentamine: a main chain including an alkylene group: a main chain having a polyalkylene glycol structure; a main chain having an alkyl ether structure; a main chain having a polyalkylene carbonate structure; and a main chain including an alkyleneoxy group or a polyalkyleneoxy group. Preferred is the main chain including an alkyleneoxy group or a polyalkyleneoxy group.

The polyalkyleneoxy group is a divalent linking group including an alkyleneoxy as the repeating unit: examples include “—(CH₂CH₂O)ₙ—” in which the ethyleneoxy unit is the repeating unit and “—(CH₂—CH(—CH₃)O)ₘ—” in which the propyleneoxy unit is the repeating unit (n and m are repeat numbers). In the polyalkyleneoxy group, the repeat number of the alkyleneoxy unit is preferably 2 to 50, more preferably 2 to 20, still more preferably 2 to 15. The polyalkyleneoxy group may include a plurality of alkyleneoxy unit species.

The number of carbon atoms of the alkylene moiety of the alkyleneoxy group and the alkylene moiety of the alkyleneoxy unit constituting the polyalkyleneoxy group is preferably 1 to 10, more preferably 2 to 10. Examples of the alkylene group constituting the alkyleneoxy group include a methylene group, an ethylene group, a propylene group, and a butylene group. As the alkyleneoxy group or the alkylene group constituting the polyalkyleneoxy group, a butylene group is preferably included because the polyimide film formed from the polyimide composition according to the present disclosure exhibits high breaking strength.

In the main chain of R₁ or R_{2,} the groups linking together the alkyleneoxy group or the polyalkyleneoxy group and the amino end groups are not particularly limited and may be, for example, alkylene groups, arylene groups, alkylenecarbonyloxy groups, or arylenecarbonyloxy groups: from the viewpoint of improving the reactivity of the amino end groups, alkylene groups are preferred.

The aliphatic chains represented by R₁ and R₂ may further include a side chain constituted by one or more atoms of C, N, H, and O. Such side chains in R₁ and R₂ are monovalent groups linking to atoms constituting the main chains. The total number of atoms constituting each of the side chains is preferably 10 or less. Examples of the side chains include, in addition to alkyl groups such as a methyl group, a hydrogen atom.

Thus, the aliphatic diamine (β2) represented by General formula (3) or (4) includes a long aliphatic chain and hence the resultant polyimide has high flexibility.

The aliphatic diamine represented by General formula (3) is preferably a compound represented by General formula (3-1). The aliphatic diamine represented by General formula (4) is preferably a compound represented by General formula (4-1).

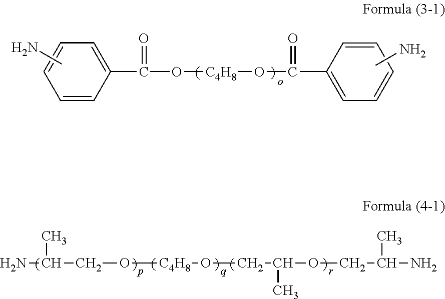

In General formula (3-1), o represents an integer of 1 to 50, preferably an integer of 10 to 20. In General formula (4-1), p, q, and r each independently represent an integer of 0 to 10 with the proviso that p+q+r is 1 or more, preferably 5 to 20.

The aliphatic diamine represented by General formula (3-1) or (4-1) includes a long-chain alkyleneoxy group and hence the resultant polyimide has high flexibility.

The aliphatic diamine (β2) represented by General formula (3) or (4) has a weight-average molecular weight of, for example, preferably 100 to 5000, more preferably 250 to 1500, still more preferably 500 to 1300. When the aliphatic diamine (β2) has a weight-average molecular weight of a predetermined value or more, the alkyleneoxy group is appropriately long and hence the flexibility or the re-dissolvability of the polyimide tends to be further improved: when the weight-average molecular weight is a predetermined value or less, the heat resistance of the polyimide tends not to be degraded.

The weight-average molecular weight of the aliphatic diamine (β2) can be measured by gel permeation chromatography (GPC).

The diamine constituting the polyimide may include, in addition to the aromatic diamine (β1) not having a benzophenone skeleton but having a diphenyl ether skeleton and the aliphatic diamine (β2), another diamine. The other diamine is not particularly limited and is an aromatic diamine other than the aromatic diamine (β1), an aliphatic diamine other than the aliphatic diamine (β2), or an alicyclic diamine: from the viewpoint of improving the heat resistance, an aromatic diamine other than the aromatic diamine (β1) is preferred.

Examples of the aromatic diamine other than the aromatic diamine (1) include, m-phenylenediamine, o-phenylenediamine, p-phenylenediamine, m-aminobenzylamine, p-aminobenzylamine, bis(3-aminophenyl) sulfide, (3-aminophenyl)(4-aminophenyl) sulfide, bis(4-aminophenyl) sulfide, bis(3-aminophenyl) sulfoxide, (3-aminophenyl)(4-aminophenyl) sulfoxide, bis(3-aminophenyl) sulfone, (3-aminophenyl)(4-aminophenyl) sulfone, bis(4-aminophenyl) sulfone, 3,3′-diaminodiphenylmethane, 3,4′-diaminodiphenylmethane, 4,4′-diaminodiphenylmethane, 3,3′-dimethylbenzidine, 3,4′-dimethylbenzidine, 4,4′-dimethylbenzidine, 2,2′-bis(trifluoromethyl)-1,1′-biphenyl-4,4′-diamine, 4,4′-bis(4-aminophenyl)-1,4-diisopropylbenzene, 3,4′-bis(4-aminophenyl)-1,4-diisopropylbenzene, 3,3′-bis(4-aminophenyl)-1,4-diisopropylbenzene, bis [4-(3-aminophenoxy)phenyl]methane, bis[4-(4-aminophenoxy)phenyl]methane, 1,1-bis[4-(3-aminophenoxy)phenyl]ethane, 1,1-bis[4-(4-aminophenoxy)phenyl]ethane, 1,2-bis[4-(3-aminophenoxy)phenyl]ethane, 1,2-bis[4-(4-aminophenoxy)phenyl]ethane, 2,2-bis[4-(3-aminophenoxy)phenyl]propane, 2,2-bis[4-(4-aminophenoxy)phenyl]propane, 2,2-bis[4-(3-aminophenoxy)phenyl]butane, 2,2-bis[3-(3-aminophenoxy)phenyl]-1,1,1,3,3,3-hexafluoropropane, 2,2-bis[4-(4-aminophenoxy)phenyl]-1, 1, 1,3,3,3-hexafluoropropane, 4,4′-bis(3-aminophenoxy)biphenyl, 4,4′-bis(4-aminophenoxy)biphenyl, 3,3′-bis(4-aminophenoxy)biphenyl, bis[4-(3-aminophenoxy)phenyl] ketone, bis[4-(4-aminophenoxy)phenyl] ketone, bis[4-(3-aminophenoxy)phenyl] sulfide, bis[4-(4-aminophenoxy)phenyl] sulfide, bis[4-(3-aminophenoxy)phenyl] sulfoxide, bis[4-(aminophenoxy)phenyl] sulfoxide, bis[4-(3-aminophenoxy)phenyl] sulfone, bis[4-(4-aminophenoxy)phenyl] sulfone, 4,4′-bis [4-(4-amino-α,α-dimethylbenzyl)phenoxy]benzophenone, 4,4′-bis[4-(4-amino-α,α-dimethylbenzyl)phenoxy]diphenyl sulfone, bis[4-{4-(4-aminophenoxy)phenoxy}phenyl] sulfone, 1,4-bis[4-(4-aminophenoxy)-α,α-dimethylbenzyl]benzene, and 1,3-bis[4-(4-aminophenoxy)-α,α-dimethylbenzyl]benzene. Of these, from the viewpoint of, without considerably degrading the flexibility, obtaining high heat resistance, the aromatic diamine other than the aromatic diamine (β1) can preferably include an aromatic diamine (3) having a biphenyl skeleton such as 3,3′-bis(4-aminophenoxy)biphenyl, 2,2′-bis(trifluoromethyl)-1,1′-biphenyl-4,4′-diamine, 3,3′-dimethylbenzidine, 3,4′-dimethylbenzidine, or 4,4′-dimethylbenzidine.

Examples of the aliphatic diamine include ethylenediamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diaminoundecane, and 1,12-diaminododecane; of these, ethylenediamine is preferred.

Examples of the alicyclic diamine include cyclobutanediamine, 1,2-cyclohexanediamine, 1,3-cyclohexanediamine, 1,4-cyclohexanediamine, except for 1,4- di(aminomethyl)cyclohexane [bis(aminomethyl)cyclohexane bis(aminomethyl)cyclohexane], diaminobicycloheptane, diaminomethylbicycloheptane (including norbornanediamines such as norbornanediamine), diaminooxy bicycloheptane, diaminomethyloxy bicycloheptane (including oxanorbornanediamine), isophoronediamine, diaminotricyclodecane, diaminomethyltricyclodecane, bis(aminocyclohexyl)methane [or methylenebis(cyclohexylamine)], and bis(aminocyclohexyl)isopropylidene. Of these, preferred are norbornanediamine, 1,2-cyclohexanediamine, 1,3-cyclohexanediamine, and 1,4-cyclohexanediamine because, without considerably degrading the flexibility, the heat resistance can be improved.

Note that, as described above, the diamine constituting the polyamic acid preferably substantially does not include the aromatic diamine (84) having a benzophenone skeleton. Examples of the aromatic diamine (84) having a benzophenone skeleton include an aromatic diamine having a benzophenone skeleton and represented by General formula (6).

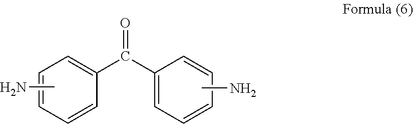

Examples of the aromatic diamine having a benzophenone skeleton and represented by General formula (6) include 3,3′-diaminobenzophenone, 3,4-diaminobenzophenone, and 4,4′-diaminobenzophenone.

The total amount of the aromatic tetracarboxylic dianhydride (α1) not having a benzophenone skeleton but having a diphenyl ether skeleton and the aromatic diamine (β1) not having a benzophenone skeleton but having a diphenyl ether skeleton (the total amount of the monomer (A)) relative to the total amount of the tetracarboxylic dianhydride and the diamine constituting the polyamic acid (the total amount of all the monomers) is preferably 30 to 97mol %, more preferably 30 to 90mol %, more preferably 40 to 85mol %, still more preferably 55 to 75mol %. When the total amount of the aromatic tetracarboxylic dianhydride (α1) and the aromatic diamine (β1) is 30mol % or more, a polyimide having heat resistance and high re-dissolvability tends to be obtained.

In the tetracarboxylic dianhydride constituting the polyamic acid, the content of the aromatic tetracarboxylic dianhydride (α1) not having a biphenyl skeleton or a benzophenone skeleton but having a diphenyl ether skeleton is not particularly limited as long as it satisfies such a range but is preferably, relative to the total amount of the tetracarboxylic dianhydride constituting the polyamic acid (or the total amount of the aromatic tetracarboxylic dianhydride (α1) having a diphenyl ether skeleton and the aromatic tetracarboxylic dianhydride (αa2) having a biphenyl skeleton), 30 mol % or more, more preferably 35 to 70mol %, still more preferably 40 to 60mol %. When the content of the aromatic tetracarboxylic dianhydride (α1) is 30 mol % or more, the resultant polyimide tends to have further improved re-dissolvability.

In the diamine constituting the polyamic acid, the content of the aromatic diamine (β1) not having a biphenyl skeleton or a benzophenone skeleton but having a diphenyl ether skeleton represented by General formula (2) is not particularly limited as long as it satisfies such a range but is preferably, from the viewpoint of sufficiently improving the heat resistance of the resultant polyimide, relative to the total amount of the diamine constituting the polyamic acid (or the total amount of the aromatic diamine (1) and the aliphatic diamine (β2)), 50 to 95mol %, more preferably 65 to 90mol %. When the content of the aromatic diamine (β1) is in such a range, the resultant polyimide tends to have further improved heat resistance.

In the diamine constituting the polyamic acid, the amount of the aliphatic diamine (β2) represented by General formula (3) or (4) (the total amount of the diamine represented by General formula (3) or (4)) is, from the viewpoint of, without considerably degrading the heat resistance of the resultant polyimide, imparting high flexibility, relative to the total amount of the diamine constituting the polyamic acid (or the total amount of the aromatic diamine (β1) and the aliphatic diamine (β2)), preferably 5 to 45mol %, more preferably 10 to 30mol %. When the content of the aliphatic diamine (β2) is in such a range, with the heat resistance of the resultant polyimide being maintained, a mechanical property such as elongation tends to be further improved.

The total amount of the aromatic tetracarboxylic dianhydride (α2) having a biphenyl skeleton and the aromatic diamine (β3) having a biphenyl skeleton (the total amount of the monomer (C) having a biphenyl skeleton) is not particularly limited but is preferably 50mol % or less, more preferably, from the viewpoint of sufficiently improving the heat resistance of the resultant polyimide, relative to the total amount of the tetracarboxylic dianhydride and the diamine constituting the polyamic acid (the total amount of all the monomers), 5 to 50mol %, still more preferably 20 to 40mol %. When the content of the aromatic tetracarboxylic dianhydride (α2) is in such a range, with the mechanical property or the re-dissolvability of the resultant polyimide being maintained, the heat resistance tends to be further improved.

The monomer composition of the polyamic acid can be determined by, for example, performing hydrolysis using alkali and subjecting the separated components to NMR analysis.

In order to provide the polyamic acid having, at a molecular end, an acid anhydride group, the amount of the tetracarboxylic dianhydride component (a mol) is made larger than the amount of the diamine component (b mol) in the reaction. Specifically, the molar ratio of the diamine (b mol) to the tetracarboxylic dianhydride (a mol) constituting the polyamic acid is preferably b/a=0.90 to 0.999, more preferably 0.95 to 0.995, still more preferably 0.97 to 0.995. When b/a is 0.999 or less, the resultant polyimide tends to have, at a molecular end, an acid anhydride group, so that re-dissolvability tends to be obtained. b/a can be determined as the charging ratio between the tetracarboxylic dianhydride component (a mol) and the diamine component (b mol) for the reaction.

The polyamic acid may be a random polymer or may be a block polymer.

The polyamic acid preferably has an intrinsic viscosity η of, from the viewpoint of ease of film formation, 0.3 to 2.0 dL/g, more preferably 0.5 to 1.5 dL/g. The intrinsic viscosity (η) of the polyamic acid is the average of values of the polyamic acid dissolved so as to have a concentration of 0.5 g/dL in N-methyl-2-pyrrolidone (NMP), the values being measured at 25° C. three times using a Ubbelohde viscosity tube.

The intrinsic viscosity (η) of the polyamic acid can be adjusted using the molar ratio (b/a) of the diamine (b mol) to the tetracarboxylic dianhydride (a mol) constituting the polyamic acid.

The polyamic acid is imidized to form a polyimide (film) that can have heat resistance (Tg, T_{d5}), re-dissolvability, and a mechanical property (elongation) described later.

1-2. Other Component

The polyamic acid composition according to the present disclosure may include, as needed, in addition to the above-described polyamic acid, another component.

For example, the polyamic acid composition may further include a solvent. The solvent may be a solvent used for preparation of the polyamic acid and is not particularly limited as long as it is a solvent in which the above-described diamine component and tetracarboxylic dianhydride component can be dissolved. Examples include aprotic polar solvents and alcohol-based solvents.

Examples of the aprotic polar solvents include N-methyl-2-pyrrolidone, N,N-dimethylformamide, N,N-dimethylacetamide, dimethyl sulfoxide, hexamethylphosphoramide, 1,3-dimethyl-2-imidazolidinone, 3-methoxy-N,N-dimethylpropanamide: and ether-based compounds such as 2-methoxyethanol, 2-ethoxyethanol, 2-(methoxymethoxy)ethoxyethanol, 2-isopropoxyethanol, 2-butoxyethanol, tetrahydrofurfuryl alcohol, diethylene glycol, diethylene glycol monomethyl ether, diethylene glycol monoethyl ether, diethylene glycol monobutyl ether, triethylene glycol, triethylene glycol monoethyl ether, tetraethylene glycol, 1-methoxy-2-propanol, 1-ethoxy-2-propanol, dipropylene glycol, dipropylene glycol monomethyl ether, dipropylene glycol monoethyl ether, tripropylene glycol monomethyl ether, polyethylene glycol, polypropylene glycol, tetrahydrofuran, dioxane, 1,2-dimethoxyethane, diethylene glycol dimethyl ether, and diethylene glycol diethyl ether.

Examples of the alcohol-based solvents include methanol, ethanol, 1-propanol, 2-propanol, tert-butyl alcohol, ethylene glycol, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, 1,2,6-hexanetriol, and diacetone alcohol.

Such solvents may be included alone or in combination of two or more thereof. Of these, preferred are N,N-dimethylacetamide, N-methyl-2-pyrrolidone, 1,3-dimethyl-2-imidazolidinone, 3-methoxy-N,N-dimethylpropanamide, and mixed solvents thereof.

In the polyamic acid varnish, the concentration of the resin solid content is, from the viewpoint of, for example, improving the coatability, preferably 5 to 50 wt %, more preferably 10 to 30wt %.

Method for Producing Polyamic Acid Composition

The polyamic acid composition can be obtained by adding, to a solvent, a tetracarboxylic dianhydride component and a diamine component and causing these to react. The types and amount ratios of the solvent, the tetracarboxylic dianhydride component, and the diamine component used have been described above.

The reaction for obtaining the polyamic acid composition is preferably performed by heating the above-described tetracarboxylic dianhydride and diamine in a solvent at a relatively low temperature (temperature at which imidization does not occur). The temperature at which imidization does not occur may be specifically 5 to 120° C., more preferably 25 to 80° C. The reaction is preferably performed in an environment in which imidization catalysts (such as triethylamine) are substantially not present.

2. Polyimide Composition

The polyimide composition according to the present disclosure includes a specific polyimide obtained by imidizing the above-described polyamic acid included in the polyamic acid composition. The polyimide composition including the specific polyimide can be obtained by heating the above-described polyamic acid composition to imidize the polyamic acid. The polyimide composition according to the present disclosure may be a film.

The temperature at which the polyamic acid is imidized may be, for example, 150 to 200° C. Thus, in the case of rapidly increasing the temperature of the coating film to 200° C. or more, before evaporation of the solvent from the coating film, the polyamic acid in the surface of the coating film is imidized. As a result, the solvent remaining in the coating film may form bubbles or irregularities in the surface of the coating film. Thus, in the temperature region of 50 to 200° C., the temperature of the coating film is preferably gradually increased. Specifically, in the temperature region of 50 to 200° C., the temperature increase rate is preferably set to 0.25 to 30° C./min, more preferably 1 to 20° C./min, still more preferably 2 to 10° C./min. The heating is preferably performed in the temperature region of 50 to 200° ° C. for 30 minutes. For preferred imidization conditions, the temperature is increased in the air atmosphere from 50° C. to 200° C. at 5° C./min and heating at 200° C. for 30 minutes is performed.

The temperature increase may be performed continuously or stepwise (step by step) but preferably continuously performed from the viewpoint of suppressing appearance defects of the resultant polyimide film. In the above-described entire temperature range, the temperature increase rate may be constant or may be changed at intermediate points.

Thus, the polyimide composition (a polyimide, a polyimide film, or the like) obtained by subjecting a polyamic acid composition according to the present invention to heating under the above-described conditions and imidization preferably satisfies properties below.

(1) Heat Resistance

(Glass transition temperature (Tg))

The glass transition temperature of the polyimide film is preferably 95° C. or more and less than 260° C., more preferably 110 to 170° C. Polyimides having glass transition temperatures in such a range have high heat resistance and hence are suitable as adhesives used for, for example, electronic circuit substrates and semiconductor devices.

The glass transition temperature of the polyimide film can be measured in the following manner. The obtained polyimide film is cut to a size of 5 mm in width and 22 mm in length. The glass transition temperature (Tg) of the obtained sample is measured using a thermal analysis apparatus (such as TMA-50 manufactured by SHIMADZU CORPORATION). Specifically, in the air atmosphere, the measurement is performed under conditions of a temperature increase rate of 5° C./min and a tension mode (100 mN) to determine a TMA curve: in the TMA curve, with respect to the point of inflection due to glass transition, curves before and after the point of inflection are extrapolated, so that the value of the glass transition temperature (Tg) can be determined.

(Temperature of 5% Weight Loss (T_{d5}))

The temperature of 5% weight loss (T_{d5}) of the polyimide film in the air atmosphere is, from the viewpoint similar to that described above, preferably 300° C. or more, more preferably 320° C. or more. The upper limit of T_{d5} of the polyimide film is not particularly limited but can be set to, for example, 600° C. or 500° C.

Tg or T_{d5} of the polyimide film can be adjusted using the monomer composition of the polyamic acid. For example, the content of the aromatic diamine (β1) constituting the polyamic acid, not having a benzophenone skeleton, but having a diphenyl ether skeleton can be increased or the content of the aromatic tetracarboxylic dianhydride (α2) having a biphenyl skeleton can be increased, so that Tg or T_{ds} of the resultant polyimide film can be increased.

(2) Re-dissolvability

The polyimide film obtained by imidizing the polyamic acid preferably has, from the viewpoint of, in the case of being used as, for example, an adhesive, being dissolved in a solvent to facilitate peeling, high dissolvability in the solvent. Specifically, the polyimide film obtained by imidizing the polyamic acid is immersed in N-methyl-2-pyrrolidone at 80° C. for 3 minutes and subsequently filtered through filter paper to determine the dissolution ratio represented by Expression (1) below, which is preferably 85% or more, more preferably 90% or more.

dissolution ratio (%)={1−[(weight of filter paper after filtration and drying)−(weight of filter paper before use)]/(weight of film before immersion)}×100 Expression (1)

The re-dissolvability can be measured in the following manner.

1) The above-described polyamic acid composition is imidized and the resultant polyimide film is cut to dimensions of 20 μm in thickness and 2.0 cm×2.0 cm to prepare a sample: the weight (weight of film before immersion) of the sample is measured in advance.

For the imidization conditions, as described above, the temperature increase rate in the air atmosphere in the temperature region of 50 to 200° C. is preferably set to 0.25 to 30° C./min, more preferably 1 to 20° C./min, still more preferably 2 to 10° C./min; the heating is performed in the temperature region of 50 to 200° C. for 30 minutes. For preferred imidization conditions, in the air atmosphere, the temperature is increased from 50° C. to 200° C. at 5° C./min and heating at 200° C. is performed for 30 minutes. In addition, the weight of the filter paper before use is measured in advance.

2) Subsequently, the sample is added to N-methyl-2-pyrrolidone (NMP) to provide a sample liquid at a concentration of 1 mass %; the obtained sample liquid is left at rest for 3 minutes in an oven heated at 80° C. Subsequently, the sample liquid is taken out of the oven, filtered through filter paper, and then subjected to reduced-pressure drying at 100° C. Subsequently, the weight of the filter paper after filtration and drying is measured.

3) The measured values in 1) and 2) above are substituted into Expression (1) above to calculate the dissolution ratio. These procedures (the above-described procedures 1) to 3)) are performed with n=2 and the average value is determined as the dissolution ratio (%).

Note that the size (such as thickness) of the sample is preferably the above-described size but may alternatively be a somewhat different size.

The re-dissolvability of the polyimide film can be adjusted using the type of the molecular-end group or the composition of the polyamic acid serving as the precursor of the polyimide film. For example, the polyamic acid is provided so as to have a molecular-end group that is an acid anhydride group, so that the resultant polyimide tends to have improved re-dissolvability. For monomers constituting the polyamic acid, the content of the monomer (A) not having a benzophenone skeleton but having a diphenyl ether skeleton (in particular, the content of the aromatic tetracarboxylic dianhydride (α1) not having a benzophenone skeleton but having a diphenyl ether skeleton) can be increased, the content of the monomer (B) having a benzophenone skeleton can be minimized, or the content of the aliphatic diamine (β2) represented by General formula (3) or (4) can be increased, so that the resultant polyimide tends to have improved re-dissolvability.

(3) Mechanical Property (Elongation)

When the polyamic acid is imidized to form a film having a thickness of 20 μm, the percentage elongation at 23° C. is preferably 40% or more, more preferably 55% or more, still more preferably 80% or more, particularly preferably 130% or more.

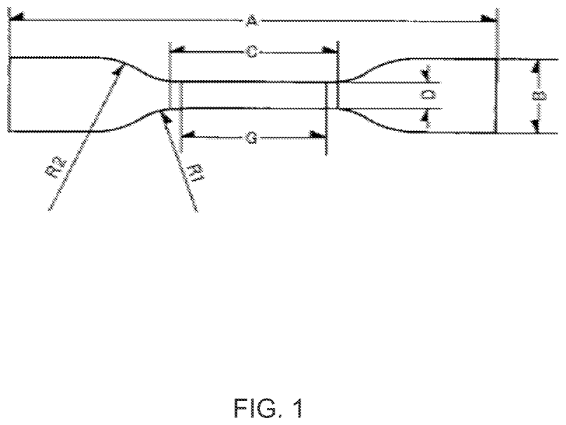

The percentage elongation of the polyimide film can be measured in the following manner. FIG. 1 is a schematic view of a test piece used in a tensile break test.

1) First, the polyimide film is punched out into a dumbbell shape illustrated in FIG. 1, to provide a sample film with A: 50 mm, B: 10 mm, C: 20 mm, and D: 5 mm.

2) Subsequently, the sample film is set on a tensile testing apparatus EZ-S (manufactured by SHIMADZU CORPORATION) and subjected to tension in the longitudinal direction (direction denoted by A) at 23° C. at a speed of 50 mm/min with a gripping distance of 30 mm. Subsequently, (length of sample film at break—initial length of sample film)/(initial length of sample film)×100 (%) can be determined as “percentage elongation at tensile break”.

The percentage elongation of the polyimide film can be adjusted using the composition of the polyimide. For example, the content of the monomer (A) constituting the polyimide, not having a benzophenone skeleton, but having a diphenyl ether skeleton (in particular, the content of the aromatic tetracarboxylic dianhydride (α1) not having a benzophenone skeleton but having a diphenyl ether skeleton) can be increased or the content of the aliphatic diamine (β2) represented by General formula (3) or (4) can be increased, so that the resultant polyimide film has improved flexibility and tends to have increased percentage elongation.

3. Applications of Polyimide Composition

The polyamic acid composition according to the present disclosure can provide a polyimide that has high heat resistance and a good mechanical property and has high re-dissolvability. Thus, the polyimide composition obtained from the polyamic acid composition according to the present disclosure can be used particularly in applications in which heat resistance and re-dissolvability are required: for example, the polyimide composition can be used as adhesives, sealing members, insulating materials, substrate materials, or protective materials in electronic circuit substrate members, semiconductor devices, surge parts, and the like.

Specifically, a laminate including a substrate and a resin layer disposed on the substrate and including the polyimide composition according to the present disclosure can be provided. Preferably, a laminate including a substrate and a resin layer disposed on the substrate in a state of being in contact with the substrate and including the polyimide composition according to the present disclosure is provided. The material constituting the substrate is not particularly limited and may be a material ordinarily used. Specifically, the material constituting the substrate varies in accordance with the application but may be, for example, silicon, ceramic, metal, or resin. Examples of the metal include silicon, copper, aluminum, SUS, iron, magnesium, nickel, and alumina. Examples of the resin include urethane resin, epoxy resin, acrylic resin, polyimide, PET resin, polyamide, and polyamide-imide. The substrate more preferably includes at least one element selected from the group consisting of Si, Ga, Ge, and As, still more preferably a semiconductor substrate (a semiconductor chip, a semiconductor wafer, or the like) including at least one element selected from the group consisting of Si, Ga, Ge, and As.

The laminate can be produced by, for example, using a step of applying, onto a substrate, the polyamic acid composition according to the present disclosure and subsequently heating the polyamic acid composition to cause imidization, to form a resin layer of the polyimide composition. The heating temperature of the coating film can be set to, as described above, a temperature suitable for imidization.

Regarding Electronic Circuit Substrate Member

The polyimide composition according to the present disclosure can be used as, in a circuit substrate, in particular, a flexible circuit substrate, an insulating substrate or an adhesive material. For example, a flexible circuit substrate can include metallic foil (substrate) and an insulating layer disposed on the metallic foil and formed from the polyimide composition according to the present disclosure (obtained from the polyamic acid composition according to the present disclosure). The flexible circuit substrate can include an insulating resin film (substrate), an adhesive layer formed from the polyimide composition according to the present disclosure, and metallic foil.

Regarding Semiconductor Member

The polyimide composition according to the present disclosure can be used as an adhesive material used for adhesion between semiconductor chips or adhesion between a semiconductor chip and a substrate, a protective member for protection of the circuits of semiconductor chips, an embedding member for embedding of semiconductor chips (sealing member), or the like.

Specifically, the semiconductor member according to the present disclosure includes a semiconductor chip (substrate) and a resin layer disposed on at least one of the surfaces of the semiconductor chip and formed from the polyimide composition according to the present disclosure (formed from the polyamic acid composition according to the present disclosure). Examples of the semiconductor chip include diodes, transistors, integrated circuits (IC), and power elements. The resin layer formed from the polyimide composition may be disposed on a surface of a semiconductor chip on which terminals are formed (terminal formation surface) or may be disposed on a surface other than the terminal formation surface.

The thickness of the layer formed from the polyimide composition is preferably, for example, in a case where the polyimide composition is used to form an adhesive layer, about 1 to about 100 μm. In a case where a polyimide composition layer is formed as a circuit protective layer, the thickness is preferably about 2 to about 200 μm.

Regarding Adhesive for Surge Part

The polyimide composition according to the present disclosure can be used as an adhesive for surge parts (surge absorbers) or a sealing member for surge parts for protecting household appliances, personal computers, transportation such as automobiles, mobile devices, power sources, servers, phones, or the like from abnormal current and voltage that affect the foregoing. The polyimide composition according to the present disclosure can be used as an adhesive or a sealing member, so that adhesion or sealing of a surge part can be achieved at low temperatures and the adhesive or the sealing member has sufficient withstand voltage and heat resistance.

Of these, the polyimide composition according to the present disclosure is preferably used as, from the viewpoint of having heat resistance and a mechanical property (elongation) and having high re-dissolvability, an adhesive for an electronic circuit substrate member, a semiconductor member, a surge part, or the like, in particular, as an adhesive for a semiconductor member, an adhesive for a flexible printed substrate, an adhesive for a coverlay film, or an adhesive for a bonding sheet.

Specifically, an electronic device such as an electronic circuit substrate or a semiconductor member may be produced by using, for example, a step of preparing a laminate including a substrate, a resin layer, and a handling substrate, a step of processing the substrate, and a step of dissolving the resin layer in a solvent and peeling the processed substrate (processed article) from the handling substrate. The laminate can be obtained by, for example, applying, to one of the substrate and the handling substrate, the polyamic acid composition according to the present disclosure, subsequently imidizing the polyamic acid composition to form a layer including a polyimide composition, and subsequently bonding the other to the layer.

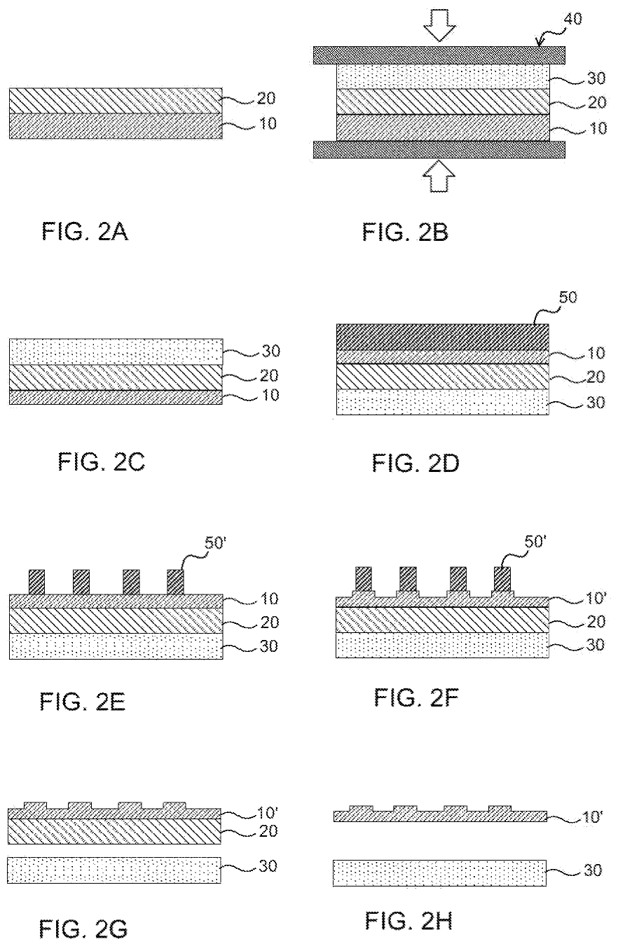

FIGS. 2A to 2H are schematic sectional views of an example of a process of using, as a temporarily fixing adhesive, the polyimide composition according to the present disclosure to process a silicon substrate. As illustrated in FIGS. 2A to 2H, for example, the polyamic acid resin composition according to the present disclosure is applied onto silicon substrate 10 (substrate) and subsequently heated and imidized, to form resin layer 20 including the polyimide resin composition (refer to FIG. 2A). Subsequently, on resin layer 20, handling substrate 30 (for example, a glass substrate) is placed and they are hot-pressed together using hot-press apparatus 40 to obtain a laminate (refer to FIG. 2B). Subsequently, the back surface of silicon substrate 10 is polished to a predetermined thickness (refer to FIG. 2C). Subsequently, on polished silicon substrate 10, resist 50 is placed to form resist pattern 50′ (refer to FIG. 2E): silicon substrate 10 is etched through resist pattern 50′ to pattern silicon substrate 10 (refer to FIG. 2F). Subsequently, handling substrate 30 is peeled using a laser or by mechanical processing from resin layer 20 (refer to FIG. 2G). Subsequently, resin layer 20 is dissolved in a solvent to peel and obtain patterned silicon substrate 10′ (refer to FIG. 2H). In the process, exposure to high temperatures of 200° C. or more occurs in, for example, the step of polishing the back surface of silicon substrate 10 (refer to FIG. 2C) and the step of etching and heat-treating silicon substrate 10 (refer to FIG. 2F).

In such manufacturing steps of electronic circuit substrates, semiconductor members, and the like, a substrate fixed on a handling substrate with a resin layer, as an adhesive, disposed therebetween is processed (including, for example, a polishing step and heating steps such as an etching and heat-treating step, electrode film formation, and a re-distribution step) and subsequently peeled together with the adhesive from the processed article without adhesive residues in some cases. By contrast, the polyimide composition according to the present disclosure (obtained from the polyamic acid composition according to the present disclosure) has heat resistance that resists heating steps, can be dissolved in a solvent or the like, and hence can be peeled without adhesive residues. Thus, the polyimide composition according to the present disclosure is suitable as an adhesive for an electronic circuit substrate, a semiconductor member, and the like and is particularly suitable as a temporarily fixing adhesive (an adhesive used for temporary adhesion and subsequent peeling).

### EXAMPLES

Hereinafter, the present disclosure will be described further in detail with reference to Examples. However, this does not limit at all the scope of the present disclosure. The following are acid anhydrides and diamines used in Examples and Comparative Examples.

(1) Acid Dianhydrides

1) aromatic tetracarboxylic dianhydride (α1) not having a benzophenone skeleton but having a diphenyl ether skeleton represented by General formula (1)
ODPA: 4,4′-oxydiphthalic anhydride

2) aromatic tetracarboxylic dianhydride (α2) having a biphenyl skeleton
S-BPDA: 3,3′,4,4′-biphenyltetracarboxylic dianhydride (manufactured by JFE Chemical Corporation)

3) aromatic tetracarboxylic dianhydride (α3) having a benzophenone skeleton
BTDA: 3,3′,4,4′-benzophenonetetracarboxylic dianhydride

(2) Diamines

1) aromatic diamine (β1) not having a benzophenone skeleton but having a diphenyl ether skeleton represented by General formula (2)
p-BAPP: 2,2-bis(4-(4-aminophenoxy)phenyl)propane
APB-N: 1,3-bis(3-aminophenoxy)benzene (manufactured by Mitsui Chemicals, Inc.)

2) aliphatic diamine (β2) represented by General formula (3) or (4)
RT1000: polyetheramine (manufactured by HUNTSMAN Corporation, refer to the following formula, Mw=1015)

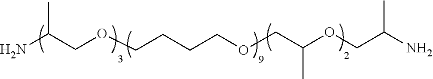

ELASMER 1000P: polyetherdiamine (manufactured by Ihara Chemical Industry Co., Ltd., amine value: 80 to 90, refer to the following formula, Mw=1268)

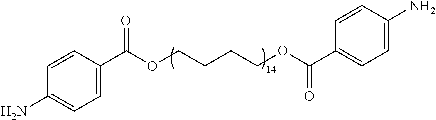

D230: polyoxypropylenediamine (manufactured by Mitsui Fine Chemicals, Inc., Mw =230)

D2000: polyoxypropylenediamine (manufactured by Mitsui Fine Chemicals, Inc., Mw=2000)

### Example 1

Preparation of Polyamic Acid Varnish (Polyamic Acid Composition)

To a solvent prepared using NMP (N-methyl-2-pyrrolidone), two acid dianhydrides (s-BPDA and ODPA) and two diamines (pBAPP and RT1000) were added in a molar ratio of s-BPDA:ODPA:pBAPP:RT1000=0.5:0.5:0.706:0.274. The resultant mixture was stirred at 40° C. for 4 hours or more within a dry-nitrogen-gas-introducible flask, to obtain a polyamic acid varnish having a resin solid content of 20 to 25 mass %.

Formation of Film

The obtained polyamic acid varnish was applied onto a glass plate at a speed of 10 mm/s, subsequently subjected to a temperature increase from 50° C. to 200° C. at 5° C./min, and heated at 200° C. for 30 minutes to remove the solvent and to cause imidization. The resultant polyimide film was peeled from the glass plate, to obtain a polyimide film having a thickness of 20 μm (polyimide composition).

### Examples 2 to 10 and Comparative Examples 1 to 2

The same procedures as in Example 1 were performed except that the types and amount ratio of the acid dianhydride and the diamine and the molar ratio of diamine/acid dianhydride were changed as described in Table 1, to prepare polyamic acid varnishes and to obtain polyimide films.

### Comparative Example 3

Preparation of Polyimide Varnish (Polyimide Composition)

To a solvent prepared using NMP (N-methyl-2-pyrrolidone) and PQ (1,2,4-trimethylbenzene) in a mass ratio of NMP:PQ=8:2, two acid dianhydrides (s-BPDA and BTDA) and three diamines (pBAPP, RT1000, and 1000P) were added in a molar ratio of s-BPDA:BTDA:pBAPP:RT1000:1000P=0.76:0.2:0.8:0.1:0.1. The resultant mixture was stirred at 40° C. for 5 hours or more within a dry-nitrogen-gas-introducible flask equipped with a Dean-Stark and a condenser, to obtain a polyamic acid varnish. Subsequently, the temperature of the solution was increased and the solution was stirred at an internal temperature of 190° C. for 8 hours or more. At this time, distilled condensation water and partially evaporated NMP and PQ were collected using the Dean-Stark. After completion of the reaction, NMP was added to adjust the concentration, to obtain a pale-yellow and viscous polyimide varnish.

Preparation of Film

The same procedures as in Example 1 were performed except that the obtained polyimide varnish was applied onto a glass plate at a speed of 10 mm/s, subsequently subjected to a temperature increase from 50° C. to 200° C. at 5° C./min, and heated at 200° C. for 30 minutes to remove the solvent, to obtain a polyimide film having a thickness of 20 μm (polyimide composition).

(Evaluation)

The intrinsic viscosities of the polyamic acid varnishes used in Examples 1 to 10 and Comparative Examples 1 and 2 and the polyimide varnish used in Comparative Example 3 were measured in the following manner.

(1) Intrinsic Viscosity η

Such an obtained polyamic acid varnish or polyimide varnish was diluted with NMP such that the concentration of the polyamic acid or polyimide became 0.5 g/dL; the intrinsic viscosity η of the resultant solution was measured in accordance with JIS K7367-1:2002 at 25° C. using a Ubbelohde viscosity tube (size No. 1) three times and the average value was determined.

In addition, the polyimide films obtained in Examples 1 to 10 and Comparative Examples 1 to 3 were evaluated in terms of (2) re-dissolvability, (3) heat resistance, and (4) percentage elongation in the following manner. Note that the molar ratio (b/a) of the diamine to the tetracarboxylic dianhydride was calculated from the charging amounts (moles) of the diamine and the tetracarboxylic dianhydride.

(2) Re-dissolvability

1) Such an obtained polyimide film was cut to dimensions of 2.0 cm×2.0 cm to prepare a sample and its weight (weight of film before immersion) was measured in advance. The weight of filter paper before use was also measured in advance.

2) Subsequently, the sample was added to N-methyl-2-pyrrolidone (in an amount providing 1 mass % of the sample, this time, 5 to 7 mL) to prepare a sample liquid: the obtained sample liquid was left at rest for 3 minutes in an oven heated at 80° C. Subsequently, the sample liquid was taken out of the oven, filtered through filter paper (pore size: 5B), and then subjected to reduced-pressure drying at 100° C. Subsequently, the weight of the filter paper after filtration and drying was measured.

3) The measured values of 1) and 2) above were substituted into Expression (1) below to calculate the dissolution ratio. These procedures (the above-described procedures 1) to 3)) were performed with n=2 and the average value was determined as the dissolution ratio (%).

dissolution ratio (%)={1−[(weight of filter paper after filtration and drying)−(weight of filter paper before use)]/(weight of film before immersion)}×100 Expression (1)

(3) Thermal Property

(Glass Transition Temperature (Tg))

The obtained polyimide film was cut to 5 mm in width and 22 mm in length. The glass transition temperature (Tg) of the sample was measured with a thermal analysis apparatus (TMA-50) manufactured by SHIMADZU CORPORATION. Specifically, the measurement was performed under conditions of the air atmosphere (air gas: 50 mL/min), a temperature increase rate of 5° C./min, and tension mode (100 mN) to determine a TMA curve: with respect to the point of inflection due to glass transition in the TMA curve, curves before and after the point of inflection are extrapolated, so that the value of the glass transition temperature (Tg) was determined.

(Temperature of 5% Weight Loss (T_{d5}))

The temperature of 5% weight loss (T_{d5}) of the obtained polyimide film was measured using a thermogravimetric analysis apparatus (TGA-60) manufactured by SHIMADZU CORPORATION. Specifically, the obtained polyimide film (in a rough amount of about 5 mg) was accurately weighed on the apparatus: the scanning temperature was set to 30 to 900° C.; in the air atmosphere, under a stream of air gas at 50 mL/min, the sample was heated under a condition of a temperature increase rate of 10° C./min and the temperature at which the mass of the sample decreased by 5% was determined as Tas.

(4) Mechanical Property

(Percentage Elongation at Tensile Break)

The obtained polyimide film was punched out into a dumbbell shape illustrated in FIG. 1 to provide a sample film with A: 50 mm, B: 10 mm, C: 20 mm, and D: 5 mm.

The obtained sample film was set on a tensile testing apparatus EZ-S (manufactured by SHIMADZU CORPORATION) and subjected to tension in the longitudinal direction (direction denoted by A) at 23° C. at a speed of 50 mm/min with a gripping distance of 30 mm. Subsequently, (length of sample film at break−initial length of sample film)/(initial length of sample film) was determined as “percentage elongation at tensile break” and the percentage elongation at tensile break of the sample film was evaluated on the basis of the following grades.

Good: a percentage elongation at tensile break of 40% or more

Poor: a percentage elongation at tensile break of less than 40%

Evaluation results of Examples 1 to 10 and Comparative Examples 1 to 3 will be described in Table 1.

TABLE 1

| | | | | | | Composition | | | | |
|---|---|---|---|---|---|---|---|---|---|---|
| | Diamine*1 | | | Acid dianhydride*1 | | | Monomer | Monomer | | |
| | First | Second | Third | First | Second | Diamine/ | (A) | (B) | | |
| | compo- | compo- | compo- | compo- | compo- | acid | content | content | | |
| | nent | nent | nent | nent | nent | dianhydride | *2 | *2 | | η |
| | (β1) | (β2) | (β2) | (α1) | (α2) | (molar ratio) | (mol %) | (mol %) | Varnish | (dL/g) |
| Example 1 | pBAPP | RT1000 | | ODPA | sBPDA | 0.98 | 60.9 | 33.8 | Polyamic | 0.88 |
| | 0.706 | 0.274 | | 0.5 | 0.5 | | | | acid | |
| Example 2 | pBAPP | RT1000 | | ODPA | sBPDA | 0.98 | 69.8 | 25.3 | Polyamic | 0.92 |
| | 0.882 | 0.098 | | 0.5 | 0.5 | | | | acid | |
| Example 3 | pBAPP | 1000P | | ODPA | sBPDA | 0.98 | 60.9 | 25.3 | Polyamic | 0.54 |
| | 0.706 | 0.274 | | 0.5 | 0.5 | | | | acid | |
| Example 4 | pBAPP | D230 | | ODPA | sBPDA | 0.98 | 60.9 | 25.3 | Polyamic | 0.57 |
| | 0.706 | 0.274 | | 0.5 | 0.5 | | | | acid | |
| Example 5 | pBAPP | D2000 | | ODPA | sBPDA | 0.98 | 60.9 | 25.3 | Polyamic | 0.74 |
| | 0.706 | 0.274 | | 0.5 | 0.5 | | | | acid | |
| Example 6 | APB-N | RT1000 | | ODPA | sBPDA | 0.98 | 69.8 | 25.3 | Polyamic | 0.54 |
| | 0.882 | 0.098 | | 0.5 | 0.5 | | | | acid | |
| Example 7 | pBAPP | RT1000 | 1000P | ODPA | sBPDA | 0.98 | 45.8 | 40.4 | Polyamic | 0.6 |
| | 0.706 | 0.137 | 0.137 | 0.2 | 0.8 | | | | acid | |
| Example 8 | pBAPP | RT1000 | 1000P | ODPA | sBPDA | 0.99 | 50.9 | 40.2 | Polyamic | 0.8 |
| | 0.812 | 0.089 | 0.089 | 0.2 | 0.8 | | | | acid | |
| Example 9 | pBAPP | RT1000 | 1000P | ODPA | sBPDA | 0.99 | 81.0 | 10.1 | Polyamic | 0.76 |
| | 0.812 | 0.089 | 0.089 | 0.8 | 0.2 | | | | acid | |
| Example 10 | pBAPP | RT1000 | | ODPA | | 0.98 | 95.1 | 0.0 | Polyamic | 1.03 |
| | 0.882 | 0.098 | | 1 | | | | | acid | |
| Comparative | pBAPP | RT1000 | | ODPA | sBPDA | 1.02 | 70.2 | 24.7 | Polyamic | 0.97 |
| Example 1 | 0.9 | 0.1 | | 0.49 | 0.49 | | | | acid | |
| Comparative | pBAPP | RT1000 | 1000P | BTDA | sBPDA | 0.98 | 45.8 | 40.4 | Polyamic | 0.64 |
| Example 2 | 0.706 | 0.137 | 0.137 | 0.2 | 0.8 | | | | acid | |
| Comparative | pBAPP | RT1000 | 1000P | BTDA | sBPDA | 1.04 | 51.0 | 38.8 | Polyimide | 0.92 |
| Example 3 | 0.8 | 0.1 | 0.1 | 0.2 | 0.76 | | | | | |

| | | | Film property | | |
|---|---|---|---|---|---|
| | Dissolution property | | Thermal | | Mechanical |
| | | Disso- | property | | property |
| | Visual observation | lution | Tg | Td5 | Elongation |
| | Dissolution time | ratio (%) | (° C.) | (° C.) | (%) |
| Example 1 | 100% dissolution | >90 | 111 | 330 | 180 |
| | 1 minute | | | | |
| Example 2 | 100% dissolution | >90 | 166 | 377 | 84 |
| | 3 minutes | | | | |
| Example 3 | 100% dissolution | >90 | 115 | 342 | 154 |
| | 2 minutes | | | | |
| Example 4 | 100% dissolution | >90 | 151 | 372 | 58 |
| | 3 minutes | | | | |
| Example 5 | 100% dissolution | >90 | 97 | 201 | 190 |
| | 1 minute | | | | |
| Example 6 | 100% dissolution | >90 | 139 | 374 | 109 |
| | 1 minute | | | | |
| Example 7 | 100% dissolution | >90 | 123 | 334 | 198 |
| | 3 minutes | | | | |
| Example 8 | 100% dissolution | >90 | 153 | 352 | 101 |
| | 3 minutes | | | | |
| Example 9 | 100% complete dissolution | >90 | 138 | 355 | 85 |
| | 2 minutes | | | | |
| Example 10 | 100% complete dissolution | >90 | 173 | 382 | 41 |
| | 3 minutes | | | | |
| Comparative | Presence of residues | 41 | 173 | 379 | 65 |
| Example 1 | 4 minutes | | | | |
| Comparative | Presence of residues | 83 | 126 | 342 | 186 |
| Example 2 | 4 minutes | | | | |
| Comparative | Presence of residues | 66 | 165 | 341 | 117 |
| Example 3 | 4 to 5 minutes | | | | |

*1The values of the components are described in molar content ratios.
*2 These are described in mol % relative to the total amount of the monomers constituting the polyamic acid.

As described in Table 1, it has been demonstrated that the polyimide films obtained using the polyamic acid varnishes of the Examples 1 to 10 have a good thermal property (Tg, T_{d5}) and a good mechanical property (elongation) and have high re-dissolvability.

In particular, it has been demonstrated that, by setting the Mw of the aliphatic diamine (β2) to more than 230 and less than 2000, the balance between re-dissolvability, the thermal property, and the mechanical property is further improved (comparison between Examples 1, 4, and 5).

In addition, it has been demonstrated that, when the content of the aromatic tetracarboxylic dianhydride (α1) having a diphenyl ether skeleton relative to the total amount of the tetracarboxylic dianhydride is 30 mol % or more, re-dissolvability is further improved (comparison between Examples 8 and 9).

By contrast, it has been demonstrated that the polyimide films obtained from the polyamic acid varnish of Comparative Example 1 and the polyimide varnish of Comparative Example 3 having diamine/acid dianhydride molar ratios of more than 1 have low re-dissolvability. In addition, it has been demonstrated that the polyimide film obtained from the polyamic acid varnish of Comparative Example 2 including (10 mol % relative to all the monomers) the monomer (B) having a benzophenone skeleton has also low re-dissolvability.

The present application claims priority to Japanese Patent Application No. 2021-047434 filed in the Japan Patent Office on Mar. 22, 2021. The entire contents described in the description of this application are incorporated herein by reference.

### INDUSTRIAL APPLICABILITY

The polyamic acid composition according to the present disclosure can provide a polyimide film having high heat resistance and a good mechanical property (elongation) and having high re-dissolvability. Thus, the obtained polyimide film is suitable as an adhesive in various fields in which high heat resistance, high flexibility, and high re-dissolvability are required. such as electronic circuit substrate members and semiconductor devices.

### REFERENCE SIGNS LIST

10 silicon substrate

10′ patterned silicon substrate

20) resin layer

30 handling substrate

40) hot-press apparatus

50) resist

50′ resist pattern

1. A polyamic acid composition comprising:
a polyamic acid provided by polycondensation of monomers that are a tetracarboxylic dianhydride and a diamine,
wherein the monomers constituting the polyamic acid include
relative to a total amount of the monomers constituting the polyamic acid,
30 to 97 mol % of a monomer (A) not having a benzophenone skeleton but having a diphenyl ether skeleton represented by General formula (1) or (2), and
0 to 5 mol % of a monomer (B) having a benzophenone skeleton,
the diamine constituting the polyamic acid includes
an aromatic diamine (31) not having a benzophenone skeleton but having a diphenyl ether skeleton represented by General formula (2), and
an aliphatic diamine (32) represented by General formula (3) or an aliphatic diamine (β2) represented by General formula (4),
a molar ratio of the diamine to the tetracarboxylic dianhydride constituting the polyamic acid is diamine/tetracarboxylic dianhydride=0.90 to 0.999, 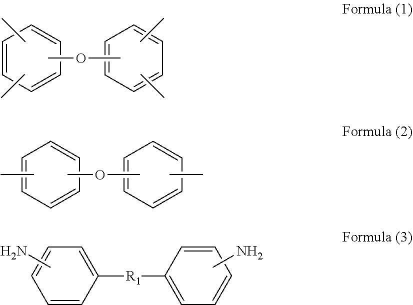
(in General formula (3), R₁ is an aliphatic chain having a main chain constituted by one or more atoms of C, N, and O and a total number of atoms constituting the main chain is 7 to 500; and
the aliphatic chain further optionally has a side chain constituted by one or more atoms of C, N, H, and O and a total number of atoms constituting the side chain is 10 or less),
H₂N—R₂—NH₂
(in General formula (4), R₂ is an aliphatic chain having a main chain constituted by one or more atoms of C, N, and O and a total number of atoms constituting the main chain is 5 to 500; and
the aliphatic chain further optionally has a side chain constituted by one or more atoms of C, N, H, and O and a total number of atoms constituting the side chain is 10 or less).

2. The polyamic acid composition according to claim 1, wherein the tetracarboxylic dianhydride constituting the polyamic acid includes an aromatic tetracarboxylic dianhydride (α1) not having a benzophenone skeleton but having the diphenyl ether skeleton represented by General formula (1) or (2),
the aromatic tetracarboxylic dianhydride (α1) is a compound represented by General formula (5), 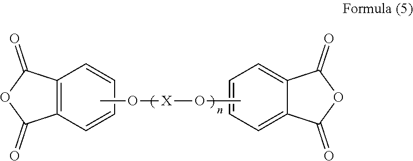
(in General formula (5),
X is an arylene group having 6 to 10 carbon atoms or a group represented by Formula (a) below, and
n represents 0 or 1), 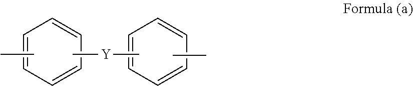
(in Formula (a) above,
Y represents a divalent group selected from the group consisting of an oxygen atom, a sulfur atom, a sulfonyl group, a methylene group, a fluorene moiety, and —CR¹R²— (R¹ and R² are a substituted or unsubstituted alkyl group having 1 to 3 carbon atoms or a phenyl group), and
R¹ and R² are optionally linked together to form a ring).

3. The polyamic acid composition according to claim 2,
wherein n in General formula (5) above is 0.

4. The polyamic acid composition according to claim 2,
wherein a content of the aromatic tetracarboxylic dianhydride (α1) relative to a total amount of the tetracarboxylic dianhydride constituting the polyamic acid is 30 mol % or more.

5. The polyamic acid composition according to claim 1,
wherein the aromatic diamine (β1) is a compound represented by General formula (2-1), 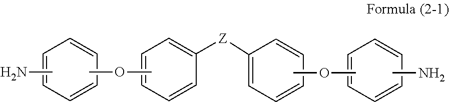
(in General formula (2-1),
Z represents a divalent group selected from the group consisting of an oxygen atom, a sulfur atom, a sulfonyl group, a methylene group, a fluorene moiety, and —CR¹R²— (R¹ and R² are a substituted or unsubstituted alkyl group having 1 to 3 carbon atoms or a phenyl group), and
R¹ and R² are optionally linked together to form a ring).

6. The polyamic acid composition according to claim 1,
wherein R¹ in General formula (3) above and R² in General formula (4) above are aliphatic chains having a main chain including an alkyleneoxy group or a polyalkyleneoxy group, and
an alkylene moiety of the alkyleneoxy group and an alkylene moiety of an alkyleneoxy unit constituting the polyalkyleneoxy group have 1 to 10 carbon atoms.

7. The polyamic acid composition according to claim 1,
wherein the aliphatic diamine (β2) represented by General formula (3) above is a compound represented by General formula (3-1) below, and
the aliphatic diamine (β2) represented by General formula (4) above is a compound represented by General formula (4-1) below, 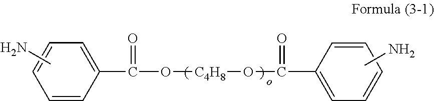
(in General formula (3-1), o represents an integer of 1 to 50), and 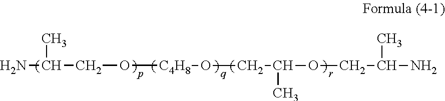
(in General formula (4-1), p, q, and r each independently represent an integer of 0 to 10 with the proviso that p +q +r is 1 or more).

8. The polyamic acid composition according to claim 1,
wherein the aliphatic diamine (β2) represented by General formula (3) above or the aliphatic diamine (32) represented by General formula (4) above has a weight-average molecular weight of 100 to 5000.

9. The polyamic acid composition according to claim 1,
wherein a content of the aliphatic diamine (β2) represented by General formula (3) above or the aliphatic diamine (β2) represented by General formula (4) above relative to a total amount of the diamine constituting the polyamic acid is 10 to 45 mol %.

10. The polyamic acid composition according claim 1,
wherein the monomer (A) and the aromatic diamine (β1) do not have biphenyl skeletons.

11. The polyamic acid composition according to claim 10,
wherein the monomers constituting the polyamic acid further include
50 mol % or less of a monomer (C) having a biphenyl skeleton relative to the total amount of the monomers constituting the polyamic acid.

12. The polyamic acid composition according to claim 1,
further comprising a solvent.

13. The polyamic acid composition according to claim 12,
wherein the solvent includes one or more selected from the group consisting of an aprotic solvent and an alcohol-based solvent.

14. The polyamic acid composition according to claim 1,
wherein a polyimide film obtained by imidizing the polyamic acid composition has a glass transition temperature of 95° C. or more and less than 260° C.

15. The polyamic acid composition according to claim 1,
wherein, in a case of imidizing the polyamic acid composition to form a film of 2.0 cm×2.0 cm×20 μm in thickness, the film has a dissolution ratio of 85% or more measured by immersing the film in N-methyl-2-pyrrolidone at 80° C. for 3 minutes and subsequent filtration through filter paper, the dissolution ratio being represented by Expression (1) below,
dissolution ratio (%)={1−[(weight of filter paper after filtration and drying) −(weight of filter paper before use)]/(weight of film before immersion)}×100. Expression (1)

16. The polyamic acid composition according to claim 1,
wherein a polyimide film obtained by imidizing the polyamic acid composition has, in air atmosphere, a temperature of 5% weight loss of 300° C. or more.

17. The polyamic acid composition according to claim 1,
wherein a film formed by imidizing the polyamic acid composition so as to have a thickness of 20 μm has a percentage elongation at 23° C. of 40% or more.

18. A polyimide composition comprising:
a polyimide provided by polycondensation of monomers that are a tetracarboxylic dianhydride and a diamine,
wherein the monomers constituting the polyimide include
relative to a total amount of the monomers constituting the polyimide,
30 to 97 mol % of a monomer (A) not having a benzophenone skeleton but having a diphenyl ether skeleton represented by General formula (1) or (2), and
0 to 5 mol % of a monomer (B) having a benzophenone skeleton,
the diamine constituting the polyimide includes
an aromatic diamine (β1) not having a benzophenone skeleton but having a diphenyl ether skeleton represented by General formula (2), and
an aliphatic diamine (β2) represented by General formula (3) or an aliphatic diamine (β2) represented by General formula (4),
a molar ratio of the diamine to the tetracarboxylic dianhydride constituting the polyimide is diamine/tetracarboxylic dianhydride=0.90 to 0.999, 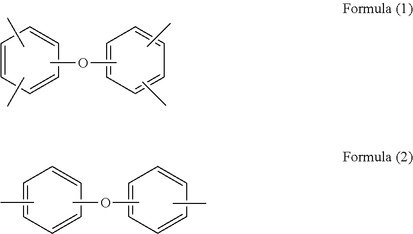 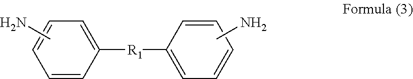
(in General formula (3), R¹ is an aliphatic chain having a main chain constituted by one or more atoms of C, N, and O and a total number of atoms constituting the main chain is 7 to 500; and
the aliphatic chain further optionally has a side chain constituted by one or more atoms of C, N, H, and O and a total number of atoms constituting the side chain is 10 or less),
H₂N—R₂—NH₂ Formula (4)
(in General formula (4), R₂ is an aliphatic chain having a main chain constituted by one or more atoms of C, N, and O and a total number of atoms constituting the main chain is 5 to 500; and
the aliphatic chain further optionally has a side chain constituted by one or more atoms of C, N, H, and O and a total number of atoms constituting the side chain is 10 or less).

19. The polyimide composition according to claim 18,
wherein the monomer (A) and the aromatic diamine (β1) do not have biphenyl skeletons.

20. An adhesive comprising:
the polyimide composition according to claim 18.

21. The adhesive according to claim 20,
wherein the adhesive is an adhesive for a semiconductor member, an adhesive for a flexible printed substrate, an adhesive for a coverlay film, or an adhesive for a bonding sheet.

22. A laminate comprising:
a substrate; and
a resin layer disposed on the substrate and including the polyimide composition according to claim 18.
